(19) United States
(12) Patent Application Publication
(10) Pub. No.: US 2001/0034921 A1
(43) Pub. Date: Nov. 1, 2001

(54) Wiper blade

(75) Inventor: Dong-Hun Kang, Seoul (KR)

Correspondence Address: ARENT FOX KINTNER PLOTKIN & KAHN, PLLC, Suite 600, 1050 Connecticut Avenue, N.W., Washington, DC, 20036-5339, US

(73) Assignee: NEXWIN CO., LTD.

(21) Appl. No.: 09/833,614

(22) Filed: Apr. 13, 2001

(30) Foreign Application Priority Data
Apr. 27, 2000 (KR) 00-11985

(51) Int. Cl. B60S 1/38

(52) U.S. Cl. 15/250.452; 15/250.451

(57) ABSTRACT

An automobile wiper blade is disclosed. A blade rubber and a frame are provided separately from each other, so that the efficiency of the wiper blade can be improved. Thus its life expectancy can be extended, the time for a replacing work can be shortened, the resources can be saved, and the economic burden to the users can be alleviated. The windshield wiper includes a motor part for generating a dynamic power, and a link part for transmitting the power of the motor. A wiper blade part wipes a windshield glass by receiving the power of the motor, and an arm part connects the wiper blade part to the link part. The wiper blade part includes a blade frame and a blade rubber separately formed from each other, the blade frame being coupled to the arm part. Departure preventing steps are formed on both ends of the arm part, for preventing any departure of the blade frame, and the blade rubber being detachable from the blade frame.

### FIELD OF THE INVENTION

The present invention relates to a wiper blade in which a blade rubber and a blade frame are separately provided, so that upon wearing-out of the blade rubber, only the blade rubber can be replaced, thereby maintaining the function of the wiper blade.

### BACKGROUND OF THE INVENTION

Generally, the windshield wiper wipes the windshield to remove the flowing water or moisture on the windshield when the front sight of the driver is shielded by a falling rain or snow. Sometimes, the wiper is installed even on the rear glass of an automobile or on the head lights. Usually the windshield wiper moves fast at a wild rain fall, and moves slow at a gentle rain fall. That is, the operation of the wiper blade consists of two stages.

The electric type windshield wiper includes: a motor part for supplying the driving power; a link part for transmitting the driving power; a wiper blade part for wiping the face of the windshield; and an arm part for connecting the blade part. There are two types, That is, a restoration type and a ferrite magnet type. The two types are same in their constitutions except in the motor parts.

In the blade part, a blade rubber is supported by a blade frame, and the middle portion of the blade frame is supported by a main arm. The lower end of the main arm is coupled to a link by using a bolt or a serration, and a spring of the main arm makes the wiper blade contacted onto the windshield with a proper force.

The wiper blade is worn more speedily or more slowly depending on its contact angle with the windshield. However, if the contact angle is too small or too large, then the wiping efficiency is deteriorated, as well as prompting the wearing of the wiper blade. Therefore the contact angle should be preferably about 30˜50°.

The conventional wiper blade has been improved over a period of several decades of years to upgrade its working efficiency, but the blade rubber and the blade frame are unitizedly coupled together, and therefore, if the blade rubber is worn out, then the whole wiper blade has to be replaced.

That is, the conventional wiper includes: a motor part for generating a dynamic power; a link part for transmitting the power; a wiper blade part for wiping the windshield by receiving the power from the motor part; and an arm part for connecting the link part to the wiper blade part.

In this conventional wiper, the blade rubber which directly contacts onto the glass wall is installed unitizedly with the blade frame which supports the blade rubber and which is connected to the arm part. Further, the wiper blade part is secured to the arm part at four supporting points.

Therefore, if the blade rubber is damaged or worn out after a long use, the whole unit of the wiper blade part has to be replaced because the blade rubber and the blade frame are unitizedly coupled.

However, the wiper blade part are secured to the arm part at four points as described above, and therefore, it is difficult to separate the wiper blade part from the arm part. Accordingly, the wiper blade part and the arm part have to be wholly replaced, and this imposes an economical burden to the users.

### SUMMARY OF THE INVENTION

The present invention is intended to overcome the above described disadvantages of the conventional technique.

Therefore, it is an object of the present invention to provide an automobile wiper blade in which the blade rubber and the blade frame are provided separately from each other, so that the efficiency of the wiper blade can be improved, its life expectancy can be extended, the time for a replacing work can be shortened, the resources can be saved, and the economical burden to the users can be alleviated.

In achieving the above object, the windshield wiper according to the present invention includes: a motor part for generating a dynamic power; a link part for transmitting the power of the motor; a wiper blade part for wiping a windshield glass by receiving the power of the motor; and an arm part for connecting the wiper blade part to the link part.

Further, the wiper blade part includes: a blade frame and a blade rubber separately formed from each other, the blade frame being coupled to the arm part; departure preventing steps formed on both ends of the arm part, for preventing any departure of the blade frame; and the blade rubber being detachable from the blade frame.

### BRIEF DESCRIPTION OF THE DRAWINGS

The above object and other advantages of the present invention will become more apparent by describing in detail the preferred embodiment of the present invention with reference to the attached drawings, in which:

FIG. 1 illustrates the constitution of the wiper blade according to the present invention;

FIG. 2 illustrates an example of the blade rubber and the blade frame according to the present invention; and

FIG. 3 illustrates an upside-down view of the blade frame according to the present invention.

### DESCRIPTION OF THE PREFERRED EMBODIMENTS

The present invention will be described in detail referring to the attached drawings.

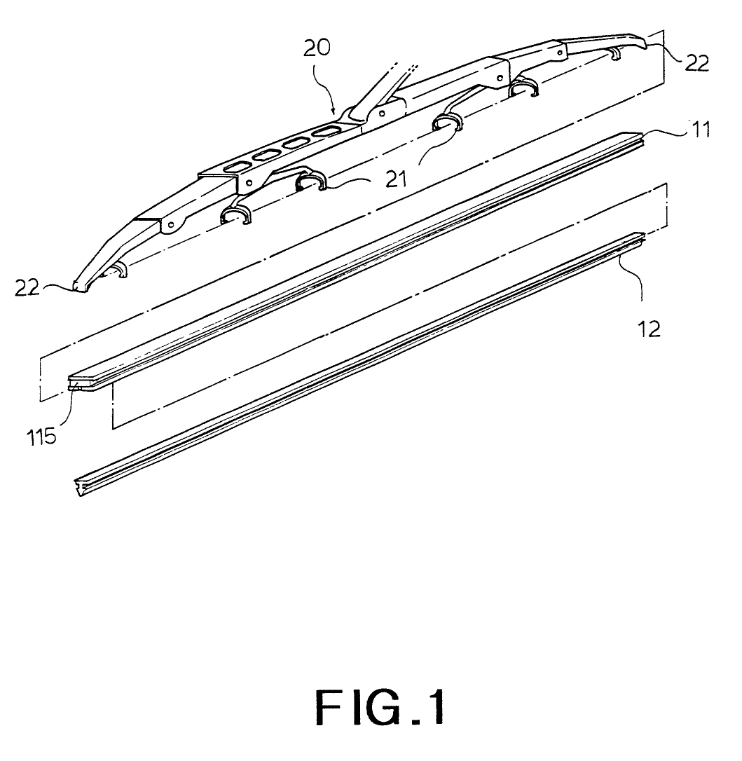

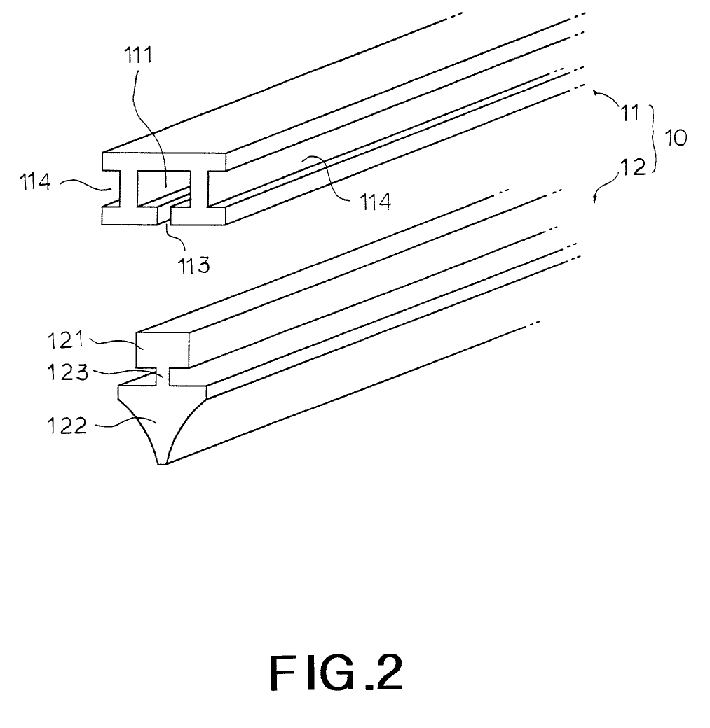

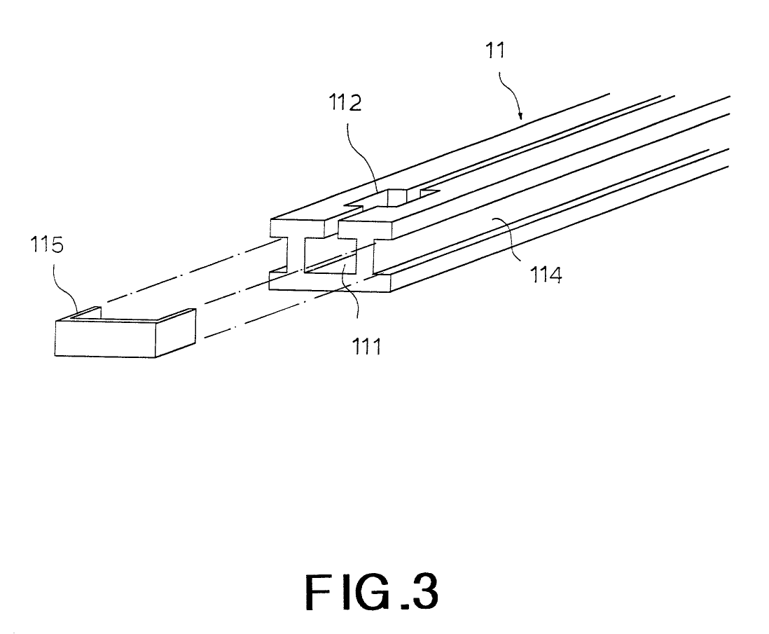

FIG. 1 illustrates the constitution of the wiper blade according to the present invention. FIG. 2 illustrates examples of the blade rubber and the blade frame according to the present invention. FIG. 3 illustrates another example of the blade frame according to the present invention.

The windshield wiper according to the present invention includes: a motor part (not illustrated) for generating a dynamic power; a link part (not illustrated) for transmitting the power of the motor; a wiper blade part 10 for wiping a windshield glass by receiving the power of the motor; and an arm part 20 for connecting the wiper blade part 10 to the link part, wherein the wiper blade part 10 consists of a wiper blade frame 11 and a blade rubber 12 in a separate form, and the blade rubber 12 is not easily detached from the blade frame 11.

The blade rubber 12 includes: an upper part 121 for being slidably installed into the blade frame 11; a lower part 122 for being directly contacted onto a glass wall surface; and an intermediate part 123 for connecting the upper part 121 and the lower part 122 together.

The blade frame 11 is that on which the blade rubber 12 is secured, and therefore, the blade frame 11 is made of an elastic material. The blade frame 11 has an elongate space 111 for receiving the upper part 121 of the blade rubber, and has a guide 113 formed in the lengthwise direction for receiving the intermediate part 123 of the blade rubber, the guide 113 communicating to the elongate space 111.

Under this condition, a pair of guide channels 114 are formed along both sides of the blade frame 11, for being engaged with a plurality of supports 21 of the arm part. Further, a pair of departure preventing means 115 are attached on both ends of the frame 11, for preventing the departure of the blade rubber 12 from the blade frame 11. Further, the blade frame 11 has an insertion hole 112 for receiving the upper part 121 of the blade rubber 12. That is, the blade rubber 12 is slidably inserted into the space 111 of the blade frame 11 by first inserting to the insertion hole 112 and then by pushing the other end of the blade rubber 12, in a sate with the pair of the departure preventing means 115 fixedly installed on both ends of the blade frame 11.

The blade rubber thus inserted into the blade frame is prevented from being departed from the blade frame by the pair of the departure preventing means 115.

The arm part 20 is linked to the link part of the wiper blade, and includes: a plurality of supporting means 21 for supporting the blade frame 11 by being engaged to the guide channels 114; and a pair of departure preventing steps 22 for preventing the departure of the blade frame 11.

Thus in the present invention, a pair of the departure preventing means 115 are fixedly attached on both ends of the blade frame 11, and the blade rubber 12 is inserted into the hole 112 to slidably insert it through the elongate space 111, thereby coupling the blade rubber 12 to the blade frame 11. This assembly is coupled to the arm part 20 and between the pair of the departure preventing steps 22 of the arm part 20 by making the guide channels 114 of the blade frame 11 engaged with the plurality of the supports 21.

That is, the blade rubber 12 is insertion-coupled to the blade frame 11, and the blade frame 11 is coupled to the arm part 20 in such a manner that the blade frame 11 should be prevented from being departed from the arm part 20 by the departure preventing steps 22 and by the plurality of the supports 21 of the arm part 20.

In the present invention as described above, if the blade rubber is worn out after a long use, then the blade rubber is taken out through the hole 112 by utilizing the elasticity and flexibility of the blade rubber 12. Then a new blade rubber 12 is inserted into the hole 112 by utilizing the elasticity and flexibility of the blade rubber 12, thereby completing the replacement.

In the above, the present invention was described based on the specific preferred embodiments and the attached drawings, but it should be apparent to those ordinarily skilled in the that various changes and modifications can be added without departing from the spirit and scope of the present invention which will be defined in the appended claims.

According to the present invention as described above, the blade rubber is replaceably installed, and therefore, if the blade rubber is worn out after a long use, then the blade rubber is taken out from the blade frame, and a new blade rubber is installed. Accordingly, the necessity of replacing the whole unit of the wiper blade in a case of disorder is dissipated. As a result, the economic burden to the users can be alleviated, and the workability and the working efficiency can be improved.

Further, the wiper blade can be provided in various colors, and therefore, the color of the blade rubber can be chosen by the users in accordance with the tastes of the users. Thus the aesthetics of automobiles can be improved.

What is claimed is:

1. A windshield wiper comprising:
a motor part for generating a dynamic power;
a link part for transmitting the power of the motor;
a wiper blade part for wiping a windshield glass by receiving the power of the motor; and
an arm part for connecting the wiper blade part to the link part;
the wiper blade part comprising:
a blade frame and a blade rubber separately formed from each other, the blade frame being coupled to the arm part;
departure preventing steps formed on both ends of the arm part, for preventing a detachment of the blade frame; and
the blade rubber being detachable from the blade frame.

2. The windshield wiper as claimed in claim 1, wherein the blade frame comprising:
an elongate space for receiving an upper part of the blade rubber;
a guide communicating to the elongate space, for receiving an intermediate part of the blade rubber;
a pair of guide channels for being engaged with a plurality of supports of the arm part;
a pair of departure preventing means fixedly attached on both ends of the blade frame; and
a hole for receiving one end of the blade rubber when replacing a new blade rubber into the blade frame.
